(19) United States
(12) Patent Application Publication
(10) Pub. No.: US 2005/0108374 A1
(43) Pub. Date: May 19, 2005

(54) Airborne radio relay system

(76) Inventors: Wayne F. Pierzga, Severna Park, MD (US); Joseph L. Pierzga, Annapolis, MD (US)

Correspondence Address: McDERMOTT, WILL & EMERY, 600 13th Street, N.W., Washington, DC, 20005-3096, US

(21) Appl. No.: 10/706,919

(22) Filed: Nov. 14, 2003

(51) Int. Cl. G06F 15/173

(52) U.S. Cl. 709/223

(57) ABSTRACT

The airborne radio-relay system includes a network control station, at least one ground station, airborne cluster controller relay stations, and one or more non-airborne stations, which may be mobile. The network control station accesses a database providing real-time four dimensional position information regarding air stations in the national and international airspace, and dynamically designates and redesignates particular airborne stations to repeat traffic in response to changing air traffic patterns so that concentric rings of overlapping relay stations are maintained. Transmitting stations use time division duplex techniques to transfer traffic, which includes packet switched data communications traffic.

### BACKGROUND OF THE INVENTION

1. Field of the Invention

The present invention relates to the field of telecommunications. More particularly, the present invention relates to a method and to a system for communicating between data terminals fitted to aircraft and a ground-based computer network through one or more airborne communication repeaters.

2. Description of the Related Art

The ability for passengers on aircraft to make telephone calls is well known. Two fundamental approaches are utilized: terrestrial-based and satellite-based air-ground communications systems.

In the mid 1980's the first terrestrial-based inflight telephony service was deployed. This service uses a network of ground stations that are each interfaced to the Public Switched Telephone Network (PSTN). Air-ground telephony traffic is passed through the ground stations. The ground stations handle air-ground telephony traffic within line-of-sight of the ground station antenna. When the aircraft passes beyond line-of-sight coverage of a particular ground station, the telephone call connection is lost and must be reestablished with a new ground station that is within the aircraft's line-of-sight. Since ground stations are terrestrially-based, communication coverage is limited to airspace over landmass areas and line-of-sight communication coverage can be obscured by land-based obstructions such as buildings, hills and mountains.

Initially such airborne phone calls utilized an analog signaling technology that was similar to that used by airborne radio stations broadcasting a modulated voice signal over a designated radio frequency to a ground-based station. The analog approach suffers from problems associated with signal degradation, requires relatively large bandwidth for carrying a voice signal, and routing of analog communication signals is, cumbersome to manage in the dynamic aeronautical environment.

In 1993 a second generation, all digital, terrestrial-based inflight telephony service was introduced in which voice signals are carried by an ISDN link on the aircraft to an air-ground radio link. Modern digital transmission and speech processing techniques are used on the voice signals before an airborne radio transceiver communicates an encoded digital voice signal between the aircraft and ground station. The digital approach delivers superior voice quality than the analog approach, and allows evolving speech encoding techniques to carry more simultaneous voice traffic over available communication channels.

In 1990 an all-digital satellite-based air-ground service was launched using the Inmarsat constellation of geostationary satellites. This service uses a network of land earth stations (LES) that are interfaced to the PSTN. Air-ground telephony traffic is passed through an aeronautical earth station (AES) fitted to the aircraft and relayed by the geostationary satellite to a designated LES. The unobstructed coverage area afforded by the satellite-based signal is quite large as compared with that provided by the terrestrial-based ground station. Consequently, the duration of uninterrupted air-ground communication with a given LES can be much greater in the satellite service than to a ground station in a terrestrial-based line-of-sight service. Nevertheless, when the aircraft passes outside the satellite coverage area, the call connection is lost and must be reestablished with an LES that serves the coverage area the aircraft has entered.

At the time the all-digital air-ground services were introduced, the public Internet was in its infancy, and the only public data service envisioned was facsimile and data modem-type calls to be made to ground-based stations or terminals. To accommodate existing facsimile and data modems that might be used on an aircraft for sending facsimile documents or e-mail messages, a speech encoder used for processing voice telephony prior to transmission is bypassed and an adaptation mechanism that permits modem signals to be sent over the radio link is inserted into the communication path instead. This type of data connection is considered to be a circuit-switched voice call, that is, a dial-up call is established for the duration of the data call and consumes one standard voice channel. As a result, the tariff for a conventional airborne data service call is the same as the tariff for a standard voice call because the procedure for setting up the two types of calls is the same and the bandwidth that is consumed by a conventional airborne data call is the same as the bandwidth consumed by a standard voice call. Moreover, the types of data services that are conveniently available through conventional airborne data service calls are severely limited because of the limited bandwidth afforded by the standard voice circuit for a conventional airborne data call. For example, conventional airborne data services support communications bandwidth of less than or equal to 9600 bit/second, and do not provide a bandwidth that is sufficient to supporting access to the Internet in which graphics, audio, video, textual and multimedia content are available.

A way is needed to provide an integrated voice-data service to airborne passengers that can mix various data services such as accessing the Internet or placing a voice call and which extends uninterrupted service to large geographic areas and thereby provides improved and more diverse communication services to passengers more efficiently than present services can support.

A variety of approaches have been proposed to extend the range of communications between aircraft and ground stations, as well as to expand the ability of cell phone users to make and receive telecommunications or radio telephone links while airborne. U.S. Pat. No. 2,571,386, issued Oct. 16, 1951, describes an Early Warning Radar System for extending a defense warning system which requires a series of aircraft flying essentially the same route where each aircraft relays radar information to the next aircraft immediately ahead and immediately behind by directive antennas. U.S. Pat. No. 2,748,266, issued May 29, 1956 to R. C. Boyd, describes a similar system having two terminal ground stations and a succession of aircraft flying in opposite directions between the two terminal stations in which successive aircraft repeat the transmissions on separate frequencies.

U.S. Pat. No. 5,530,909, issued Jun. 25, 1996 to Simon et al., discloses a method of communications on high frequency (HF) or very high frequency (VHF) by two stations which are not within line-of-sight through airborne relays of aircraft on random routes, the method requiring the airborne relays to maintain routing databases, the originating station receiving routing databases of all airborne relay stations within range and using an algorithm to select the best route for the communication, with coded address destination and routing information being added to data packets. U.S. Pat. No. 6,285,878, issued Sep. 4, 2001 to J. Lai, teaches a system of microwave repeaters on commercial aircraft for broadband communication at 30 GHz. The aircraft must fly the same route at the same speed and altitude and be spaced apart at intervals to maintain line of sight.

U.S. Pat. No. 5,412,654, issued May 2, 1995 to C. E. Perkins, teaches a method of routing packets of data between two mobile computers and an ad hoc wireless network which involves broadcasting routing tables by link layer communications so that the best route for communications can be determined and communications links are updated as the mobile computers move. U.S. Pat. No. 6,018,659, issued Jan. 25, 2000 o Ayyagari e al. discloses an airborne array of relay stations for broadband wireless communication using phased array antennas wherein each aircraft maintains a defined geographical coverage area by maintaining a specified route so that communications can be routed accordingly.

Currently the Federal Communications Commission prohibits the use of cellular telephones inside an airplane while the airplane is in flight. A passenger wishing to make a telephone call must use a centrally located telephone provided for the purpose on board the aircraft, or he must use telephones wired to the seats on the plane which are connected to a common transceiver and antenna. Currently a cellular telephone user cannot receive a telephone call while in flight, but is only forwarded a message providing the calling party's telephone numbers which the passenger must then call from the telephone(s) provided by the airline.

Several improvements in the present system. U.S. Pat. Nos. 5,519,761 and 5,559,865, issued May. 21, 1996 and Sep. 224, 1996, respectively, to K. S. Gilhousen disclose a system for airborne cellular telephone communication which includes bases stations connected to a mobile switching office, which is, in turn, connected to the public telephone switching network (PTSN)., the base stations being connected to an antenna which transmits to an airborne repeater mounted on an aircraft which repeats the transmission to airborne radiotelephones inside the aircraft.

U.S. Pat. No. 5,887,258, issued Mar. 23, 1999 to Lemozit et al., shows a device which allows the use of a mobile telephone on board an aircraft by plugging cables into a specialized jack in the telephone, the cables being connected to a beacon transceiver and antenna outside the aircraft so that electromagnetic transmission does not affect sensitive electronic systems on board the aircraft.

U.S. Pat. No. 5,950,129, issued Sep. 7, 199 to Schmid et al., describes a system in which an airline passenger can run a smart card through a card reader which records his seat assignment and cell telephone number, an aircraft radio inflight system controller transmits the corresponding location and telephone number to a ground station controller through a satellite, and the ground station controller updates the, passenger's home location register so that incoming calls for the passenger's cell phone are routed to the aircraft.

U.S. Pat. No. 6,104,926, issued Aug. 15, 2000 to Hogg et al., teaches a method for increasing frequency efficiency in an airborne telecommunications system by an improved call handoff system to maximize channel usage. U.S. Pat. No. 6,314,286, issued Nov. 6, 2001 to R. G. Zicker, discloses a method for permitting cell phone users to use their cell phones in an aircraft by setting up a cell site within the aircraft which communicates with the PTSN through a ground station, the cell site forcing the cell phone to transmit at minimum power to avoid interference with aircraft control systems.

U.S. Pat. No. 6,321,084, issued Nov. 20, 2001 to M. Horrer, teaches a method for allowing airline passengers to receive incoming calls by connecting all telephones in the airplane to a private branch exchange (PBE), assigning each passenger's phone an internal identification in the PBE, and rerouting incoming telephone calls from the passenger's cell phone number to the PBE with the internal identification number.

U.S. Pat. No. 6,236,337, issued May 22, 2001 to Beier et al. describes a device for transferring data from one mobile station to another in which each station multicasts the data it receives. The device is described as operating on 5.8 GHz, or on 64 GHz, with a range of one hundred meters, a typical application being vehicle identification so that if there is sufficient density of radio stations, police can locate stolen vehicles, Application of the system to aircraft is not described.

None of the above inventions and patents, taken either singularly or in combination, is seen to describe the instant invention as claimed. Thus an airborne radio relay system solving the aforementioned problems is desired.

### SUMMARY OF THE INVENTION

The airborne radio relay system includes a network control station, ground station, airborne relay stations, and one or more non-airborne stations, which may be mobile. The network control station accesses a database providing near real-time four dimensional position information regarding air stations in the national and international airspace, and dynamically designates and redesignates particular airborne stations to repeat traffic in response to changing air traffic patterns so that concentric rings of overlapping relay stations are maintained. Transmitting airborne and non-airborne stations use time division multiple access and time division duplex techniques to transfer traffic, which includes packet switched data communications traffic. A method of using the system for wireless data communications includes steps of accessing a database of real-time four dimensional aircraft position location, designating aircraft as airborne relay stations in concentric overlapping circles, uploading ground-to-air traffic on a first frequency using time division multiplexing techniques, designated airborne relay stations relaying traffic to other designated airborne relay stations, airborne stations and non-airborne station on a second frequency, airborne stations and non-airborne stations transmitting traffic to their local airborne relay station on the second frequency and airborne relay stations relaying the collected traffic and their own traffic to other airborne relay stations and to ground stations on the second frequency where traffic is passed by time division multiple access and time division duplex techniques.

The present invention provides a method and a communication system that provides integrated voice-data and multimedia services to the diverse base of users located on aircraft, ships and the ground using packet-switch communication techniques. The invention supports a various data services such as accessing the Internet, private Intranets or placing a voice call and extends uninterrupted service to large geographic areas thereby providing improved and more diverse communication services to users efficiently.

The advantages of the present invention are provided by a method and communications system in which data traffic is exchanged between ground-based data networks such as the Internet or a private data network and user data terminals or private networks by a system of radio repeaters fitted to aircraft of opportunity using packet-switched techniques. Data traffic from a ground-based data network is transmitted by a ground station is received directly by a first set of stations fitted to aircraft. Some of these stations are designated to serve as controllers that in turn repeat the traffic for a first time. The repeated data traffic is received by a second set of stations fitted to aircraft that are within line-of-sight of the first set controller stations. These stations are said to be members of the controller's cluster. Some of these receiving stations are instructed to serve as cluster controllers that repeat the data traffic a second time. A similar controlled repetition process is employed a third and subsequently in the reverse direction to systematically carry traffic from remote stations to their cluster controller, then from these cluster controllers to their parent cluster controllers and so forth. The ground station receives directly the signal on the second frequency from the set of cluster controllers that are within line of sight radio range of the ground station thereby forming a complete bi-directional communication path between a ground station and remote stations. This controlled relay process can be extended in a systematic manner beyond two or three repetitions so that the communication service can be extended to data terminals and data networks connected to stations that may be located well beyond the line-of-sight coverage area of the ground station.

According to the invention, the identity and location of stations that are designated airborne cluster controller (or repeater) stations changes frequently so as to maintain a connected chain of line-of-sight communication links while allowing for the aircraft to which these stations are fitted to progress their normal flight routes. According to the invention, the data carried by the network can be any form of digital traffic supported by public and private data communication networks including Internet traffic, graphics, audio, video, telephony textual and multimedia content. According to the invention, ship-borne and land-based stations can also participate in the communication system thereby extending the utility of the invention not just to data terminals and networks located on aircraft but also to data terminals and networks located on maritime platforms and the ground.

Accordingly, it is a principal object of the invention to provide a system and method for providing an airborne radio relay system for packet switched data communications.

It is another object of the invention to extend the range of wireless data communications systems through a system of airborne cluster controller repeaters.

It is a further object of the invention to simplify and reduce the cost of airborne radio relay systems by using a central control station to designate aircraft of opportunity as airborne cluster controller relay stations.

Still another object of the invention is to simplify and reduce the cost of airborne radio relay systems by allowing for both decision directed and self directed traffic routing. The use of ground-originated decision directed routing reduces communication signaling traffic and thus increases the throughput efficiency and capacity of the communication network for carrying user traffic.

Yet another object of the invention is to increase the throughput efficiency and capacity of the communication network by using time division multiple access and time division duplex techniques for forward, feeder and return communication links.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 shows a schematic block diagram of the components of an airborne radio relay system according to the present invention.

FIG. 2 is a block diagram of a ground station in an airborne radio relay system according to the present invention.

FIG. 3 is a block diagram of an airborne station in an airborne radio relay system according to the present invention.

FIG. 4 is a schematic block diagram of a non-airborne station in an airborne radio relay system according to the present invention.

FIG. 5A is a schematic diagram of a representative communication coverage according to the present invention.

FIG. 5B is a schematic diagram of a representative communication coverage area of a ground station in an airborne radio relay system according to the present invention.

FIG. 5C is a schematic diagram of a representative communication coverage area of an inner ring of airborne cluster controller relay stations in an airborne radio relay system according to the present invention.

FIG. 5D is a schematic diagram of a representative communication coverage area of an intermediate ring of airborne cluster controller relay stations in an airborne radio relay system according to the present invention.

FIG. 5D is a schematic diagram of a representative communication coverage area of an outer ring of airborne cluster controller relay stations in an airborne radio relay system according to the present invention.

FIG. 6 is a diagram of a preferred transmission timing schedule providing a systemic means for ground station, airborne stations and, non-airborne stations to share radio spectrum and thereby maintain air-ground communication links according to the present invention.

Similar reference characters denote corresponding features consistently throughout the attached drawings.

### DETAILED DESCRIPTION OF THE PREFERRED EMBODIMENTS

The present invention is a method and a system providing wireless communications between a data terminal station, such as a personal computer, laptop, handheld computer, or other data communications device located on aircraft, ships or on the ground and a ground based network, such as the Internet, using a packet-switching radio relay technology fitted to conventional commercial, private and government aircraft of opportunity. As a result, the present invention utilizes bandwidth more efficiently than conventional aeronautical, land and maritime mobile data telecommunications systems because the same communications channel is used for multiplexing data packets from a plethora of different concurrent user data sessions, facilitating multiple virtual networks and extends the telecommunications range of a single ground station well beyond the ground station's line-of-sight. The present invention reduces the number of ground stations required to provide service to large geographic areas and also extends the communication service to users located in regions that would otherwise be inaccessible for conventional line-of-sight ground-based communications due to geographic impediments, such as mountainous areas and vast oceanic expanses.

The present invention also provides a decision-directed method and system for dynamically commanding an airborne station to function as airborne cluster controller repeater station as the aircraft to which the terminal is fitted pursues its normal flight plan. The invention also provides a self-directed method and system for airborne terminals to designate themselves to serve as airborne repeater stations. Consequently, the present invention maintains the general size and shape of the extended communications coverage area and provides continuity of communication in a dynamic and changing air traffic environment.

The present invention provides air-to-air and air-to-ground communication among airborne terminals, non-airborne terminals and ground stations on what are deemed Forward, Feeder and Return communication links using a single radio frequency and frequency reuse is possible. Additionally, the present invention provides ground-to-air communication using a single radio frequency different from that used for air-to-air and air-to-ground communication and frequency reuse is possible. Consequently, the present invention utilizes frequency spectrum efficiently.

The present invention can employ only a single, transmit amplifier, no diplexer, and a non-steerable antenna allowing the construction of low-cost airborne and non-airborne stations.

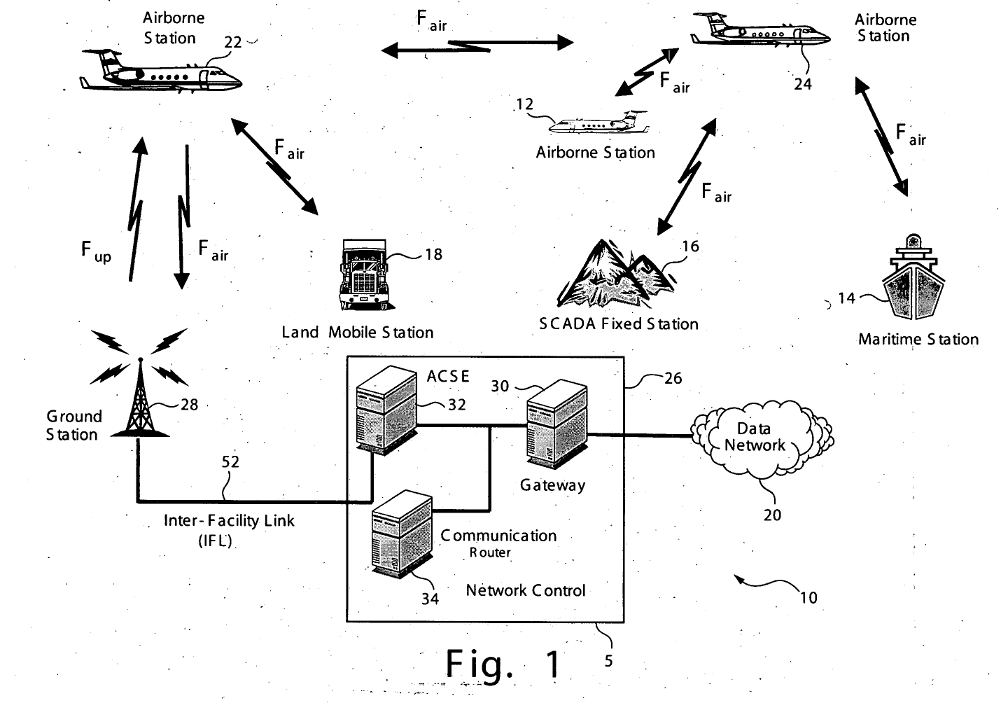

FIG. 1 shows a schematic block diagram of an airborne radio relay system 10 according to the present invention that provides a communication link between data terminals, such as a personal computer (PC), laptop, handheld/palm PC or other data communication devices and such devices connected to a local area network fitted to aircraft 12, ships 14, and fixed 16 and land mobile 18 ground platforms and a ground-based data network 20, such as the Internet using airborne cluster controller repeater stations 22 and 24 fitted to aircraft of opportunity as an intermediate relay. According to the invention, the system 10 is comprised of four parts: a network control station 26; a ground station 28; airborne stations 12, 22, and 24; and non-airborne stations 14, 16 and 18. The system 10 depicted in FIG. 1 includes a plurality of airborne stations 12, 22 and 24 and non-airborne stations 14, 16 and 18 communicating with ground station 28 forming a sub-network. The system 10 depicted in FIG. 1 includes a plurality of sub-networks interconnected and under the control of network control 26 to form a larger network, thus enabling mobile stations to move from one sub-network to another while maintaining communication connectivity.

The network control 26 acts as an intelligent gateway between a ground-based network 20 and one or more sub-networks. More specifically, gateway 30 preferably provides a well known interface between a ground-based network 20 and communications system Access Control and Signaling Equipment (ACSE) 32. ACSE 32 provides three general functions: 1) controlling and monitoring various data transport interfaces; 2) multiplexing, prioritizing, addressing, routing and formatting data packets for subsequent distribution, and; 3) reliably distributing communications traffic and distributing and maintaining communication routing databases defining the preferred path of airborne repeater stations through which traffic is relayed by the telecommunications system. Rou te processor 34 periodically computes and updates the ACSE 32 communication routing database that identifies specific airborne stations 22, 24 to function as airborne cluster controller repeater stations and relay traffic in their respective repeater regions during the ensuing period of time.

In the present invention, the routing database 32 is generated using near real-time data obtained from air traffic control authorities that describes the four-dimensional physical location (latitude, longitude; elevation, and time) of aircraft in the airspace served by the communication system. Such a database is maintained for the national and contiguous oceanic and international airspace by the Federal Aviation Administration (FAA), and is accessible by private concerns for a fee. The routing database 32 is dynamically updated by accessing the air traffic control database in order to dynamically-adjust the designation of aircraft to serve as airborne repeaters or relays in the airborne radio relay system 10 in response to changes in the air traffic pattern in the airspace covered by the communication system. Additionally, the database is updated using routing information collected by airborne terminals that have nominated themselves to function as airborne repeaters as may be the case where aircraft are outside the airspace actively controlled by an air traffic management authority such as the FAA.

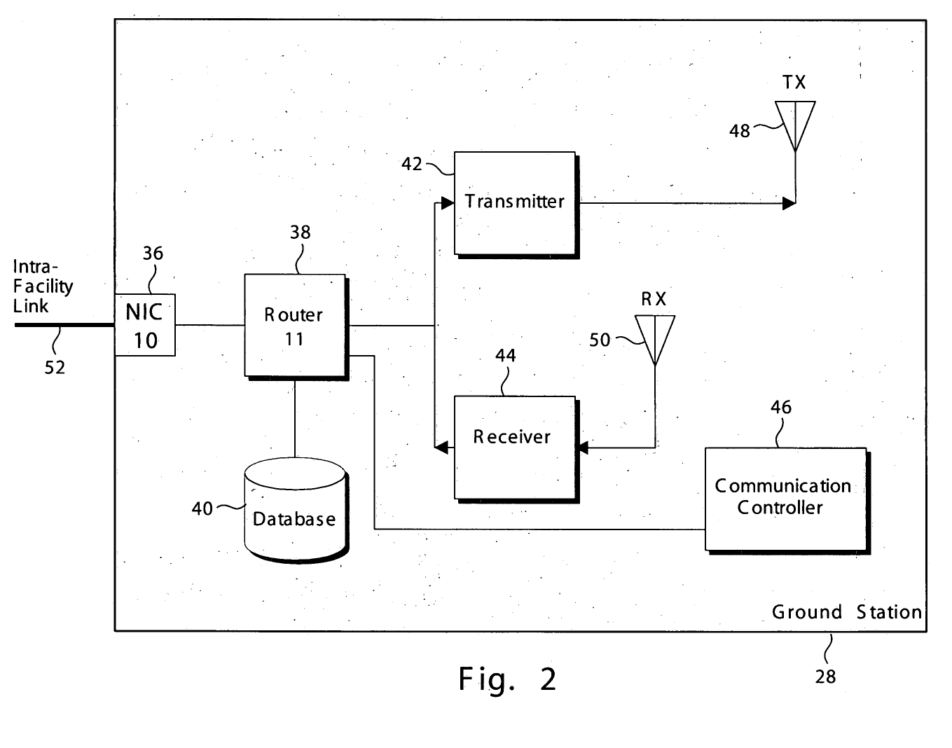

FIG. 2 shows a schematic block diagram of a ground station 28 in the present airborne radio relay system 10. The ground station 28 relays communication traffic between network control 26 and airborne stations; said communication traffic comprising user traffic and system management and routing traffic. According to the invention said ground station 28 is comprised of eight general functional parts: network-interface circuitry (NIC) 36; router 38; database 40; transmitter 42; receiver 44; and communication controller 46, all preferably physically housed in a single weather-proof enclosure; transmit antenna 48; and receive antenna 50, both antennas preferably fitted atop a radio tower. Ground station 28 is conveniently located so as to provide communication coverage to a volume of space in which there is a near constant presence of aircraft within line-of-sight of the ground station antennas.

Air-ground traffic is exchanged between ground station 28 and network control 26 through inter-facility communication link 52 via NIC 36 using well known interface and data-exchange techniques, such as fractional T1 circuits and TCP/IP protocols. Router 38 directs traffic between network interface circuit (NIC) 36, transmitter 42, receiver 44, database 40 and communication controller 46 in accordance with addressing information associated with the traffic using well known techniques. Forward ground-to-air traffic is transmitted on frequency Fᵤₚ by transmitter 42 via antenna 48 that provides omni-directional, sky-facing, hemispheric coverage.

Transmitter 42 operates using time division multiplexing (TDM) techniques and provides five general functions: 1) applies interleaving and forward error correction protection to traffic; 2) formats traffic for radio transmission; 3) transforms traffic into filtered, phase-modulated signal; 4) translates the modulated signal to the appropriate RF carrier frequency, and; 5) amplifies the modulated signal to levels suitable for transmission. Return air-to-ground traffic sent on frequency Fₐᵢᵣ is intercepted by antenna 50, also providing omnidirectional, sky-facing, hemispheric coverage, and coupled to receiver 44. Thus transmitter 42, receiver 44 and their associated antennas together provide a path for air-ground communication.

Receiver 44 operates using time division duplexing/time division multiple access techniques (TDD/TDMA) and provides five general functions: 1) amplifies the received signal using low-noise techniques to a level suitable for subsequent processing; 2) translates the received signal to a lower IF frequency appropriate for post-processing; 3) filters the translated signal to select the desired carrier frequency from a plethora of signals sharing the frequency band; 4) demodulates and recovers the digital-signal stream; 5) de-interleaves and processes the digital signal stream through FEC to recover traffic data. According to the invention, Fᵤₚ and Fₐᵢᵣ are spaced sufficiently far apart in the radio spectrum to permit simultaneous transmission and reception using well known and simple filtering techniques. Shared database 40 contains information describing the configuration, status and health of the ground station equipment that is maintained routinely by network control 26 and ground station communication controller 46, and also serves as a communication traffic buffer. Communication controller 46 monitors ground station equipment status and health and configures and controls the operation of the main functional elements of ground station 28 on a continuous basis.

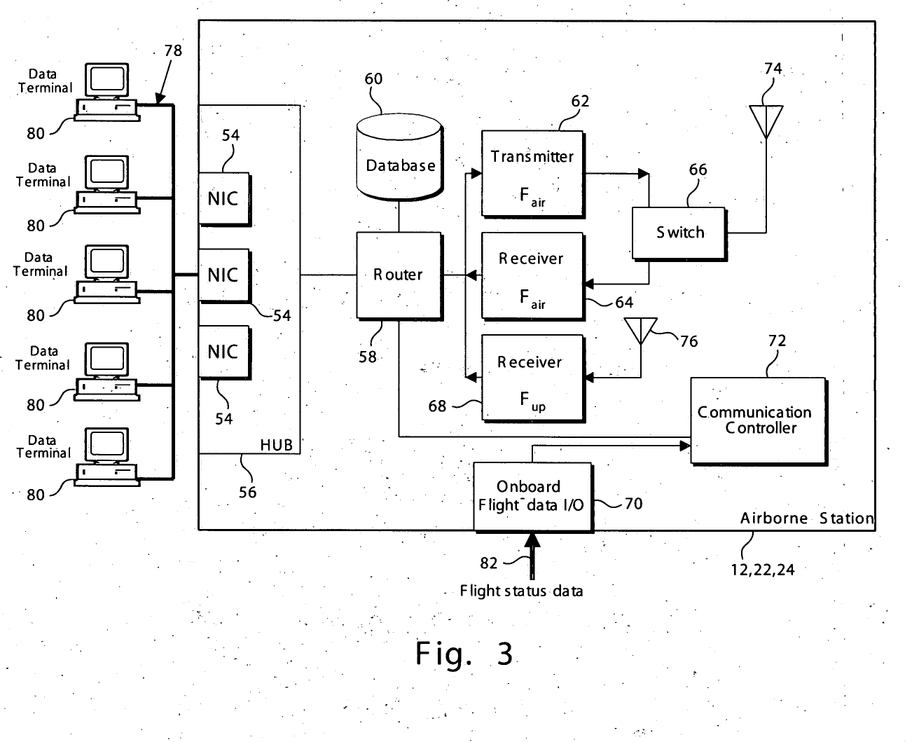

FIG. 3 shows a schematic block diagram of airborne station 12, 22, or 24. According to the invention, airborne stations are fitted to aircraft of opportunity, such as airplanes, helicopters or a space vehicles and are capable of line-of-sight communication with ground station 28, other airborne stations and non-airborne stations 14, 16 or 18. According to the invention, an airborne station is comprised of twelve general functional parts: NIC 54; HUB 56; router 58; database 60; air-transmitter 62; air-receiver 64; switch 66; ground-receiver 68; onboard flight I/O processor 70; and communication controller 72 that together can be physically enclosed within one housing, or can be physically located in separate housings distributed around the aircraft depending on the technology used and the physical constraints of the host aircraft; air-antenna 74 and ground-antenna 76 fitted to the fuselage of the host aircraft; said antennas depending on the technology used may share a common physical housing.

An airborne station provides interfaces to various data pipes that are internal to the aircraft including an existing Cabin Distribution System (CDS) 78 using a Local Area Network (LAN), Wireless Local Area Network (WLAN), Ethernet or a Fiber Distributed Data interface (FDDI) and/or Asynchronous Transmission Mode (ATM) network for distributing digital multimedia, telephony, graphics and textual information to a plurality of onboard data terminals 80 through one or more NIC 54 associated with HUB 56 in a well known manner. Data terminals 80 can include data terminals 80 that are used by flight personnel and data terminals 80 that are used by passengers. For example, a data terminal 80 may be located on the flight deck of the aircraft, while another data terminal 80 is located elsewhere onboard and used by a maintenance crew and/or members of the flight crew not located on the flight deck. Other data terminals 80 are dedicated data terminals provided onboard for the convenience of passengers and/or can be portable, laptop or handheld computers provided by passengers and/or data terminals that are part of the aircraft and used, e.g., for telemetery or for cockpit/cabin audio/video surveillance.

Router 58 directs the traffic between NICs 54 via HUB 56, database 60, air-transmitter 62, air-receiver 64, ground-receiver 68 and communications controller 73 according to addressing information associated with traffic using well known techniques. Additionally, router 58 computes routing paths for communication with other airborne and non-airborne terminals using common practice techniques, said routing to be applied in the event the airborne terminal must self-direct network communication as may happen if the aircraft is beyond the active management of an air traffic management authority. Transmitter 62, receiver 64, switch 66 and antenna 74 under the control of communication controller 72 together provide an air-to-air communication system that provides line-of-sight communications on radio frequency Fₐᵢᵣ.

Transmitter 62 operates using TDD/TDMA techniques and provides five general functions: 1) applies interleaving and forward error correction protection to traffic; 2) formats, traffic for radio transmission; 3) transforms traffic into phase-modulated signal in space; 4) translates the modulated signal to the appropriate RF carrier frequency, and; 5) amplifies the modulated signal to levels suitable for transmission. Receiver 64 operates using TDD/TDMA techniques and provides five general functions: 1) amplifies the received signal using low-noise techniques to a level suitable for subsequent processing; 2) translates the received signal to a lower IF frequency appropriate for post-processing; 3) filters the translated signal to select the desired carrier frequency; 4) demodulates and recovers the digital signal stream; 5) de-interleaves and processes the digital signal stream through FEC to recover traffic data.

Communications controller 72 monitors the status and configures and controls the equipment comprising the airborne station. For example, communication controller 72 alternately commands switch 66 to connect either transmitter 62 to antenna 74 to facilitate transmission, or to connect receiver 44 to antenna 74 to facilitate reception and commands receiver 44 to mute its input when the station is transmitting to prevent the hi-powered transmit signal from overloading and damaging the receiver 44.

Receiver 68 receives ground-to-air-signals on F^{up}, operates using TDM techniques and provides five general functions: 1) amplifies the received signal using low-noise techniques to a level-suitable for subsequent processing; 2) translates the received signal to a lower IF frequency appropriate for post-processing; 3) filters the translated signal to select the desired carrier frequency; 4) demodulates and recovers the digital signal stream; 5) de-interleaves and processes the digital signal stream through FEC to recover traffic data. Database 60 serves as a shared data store where traffic and signaling information is accumulated in anticipation of subsequent processing by communication controller 72, and also provides storage where traffic is cached for access and manipulation by data terminals 80, such as WEB page content.

Onboard flight data interface 70 provides well known interface to GPS and/or onboard navigation and flight information data-pipes 82, such as ARINC 429, from which communication processor 72 obtains information describing the identity of the host aircraft and its position in space.

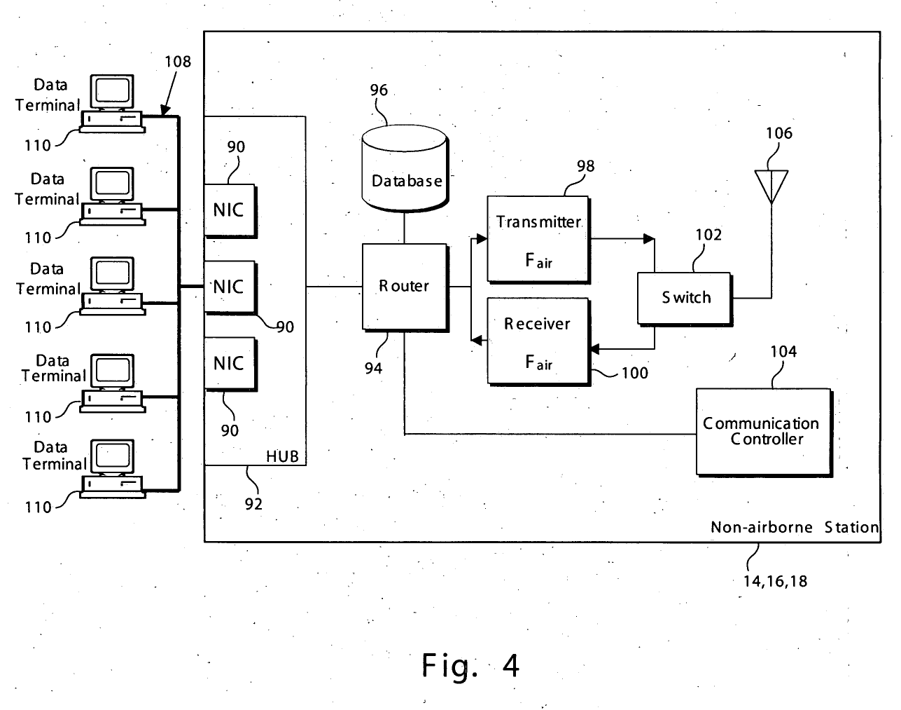

FIG. 4 shows a schematic block diagram of non-airborne station 14, 16, or 18. According to the invention, non-airborne terminals are fitted to ships and fixed and mobile ground platforms and are capable of line-of-sight communication with airborne terminals 12, 22 and 24. According to the invention, an non-airborne terminal is comprised of nine general functional parts: NIC 90; HUB 92; router 94; database 96; air-transmitter 98; air-receiver 100; switch 102; and communication controller 104 that together can be physically enclosed within one housing, or can be physically located in separate housings distributed around the host platform depending on the technology used and the physical constraints of the host platform; and air-antenna 106 fitted to the host platform so as to have an unobstructed line-of-sight to airborne repeater stations passing overhead.

A non-airborne station provides interfaces to various data pipes 108 that are internal to the platform hosting the station, including a Local Area Network (LAN), Wireless Local Area Network (WLAN), Ethernet or a Fiber Distributed Data interface (FDDI) and/or Asynchronous Transmission Mode (ATM) network for distributing digital multimedia, telephony, graphics and textual information to a plurality of onboard data terminals 110 through NIC 90 associated with HUB 92 in a well known manner. Data terminals can be devices fitted to the platform for system control and data acquisition (SCADA) or for the convenience of passengers and crew and/or can be portable, laptop or handheld computers provided by passengers and crew.

Router 94 directs the traffic between NICs 90 via HUB 92, database 96, air-transmitter 98, air-receiver 100, and communications controller 104 according to addressing information associated with traffic using well known techniques. Transmitter 98, receiver 100, switch 102 and antenna 106 under the control of communication controller 104 together provide an air-ground communication system that provides line-of-sight communications on radio frequency Fₐᵢᵣ.

Transmitter 98 operates using TDD/TDMA techniques and provides five general functions: 1) applies interleaving and forward error correction protection to traffic; 2) formats traffic for radio transmission; 3) transforms traffic into phase-modulated signal in space; 4) translates the modulated signal to the appropriate RF carrier frequency, and; 5) amplifies the modulated signal to levels suitable for transmission. Receiver 100 operates using TDD/TDMA techniques and provides five general functions: 1) amplifies the received signal using low-noise techniques to a level suitable for subsequent processing; 2) translates the received signal to a lower IF frequency appropriate for post-processing; 3) filters the translated signal to select the desired carrier frequency; 4) demodulates and recovers the digital signal stream; 5) de-interleaves and processes the digital signal stream through FEC to recover traffic data.

Communications controller 104 monitors the status and configures and controls the equipment comprising the non-airborne station. For example, communication controller 104 alternately commands switch 102 to connect either transmitter 98 to antenna 106 to facilitate transmission, or to connect receiver 100 to antenna 106 to facilitate reception, and commands receiver 100 to mute its input when transmitter 98 is operating to prevent the hi-powered transmit signal from overloading and damaging the receiver 100. Database 96 serves as a shared data store where traffic and signaling information is accumulated prior to being processed by communication controller 104, and also provides storage were traffic is cached for access by data terminals 110.

According to the invention, central network control 26 can designate any airborne station 12, 22 or 24 to function as an airborne cluster controller repeater station through signaling that encapsulates forward traffic. Airborne stations within range of the ground station receive the forward traffic, process its contents and in particular extract signaling traffic. An airborne station signalled to be an airborne cluster controller repeater station 22 relays communication traffic between: 1) ground station 28 and adjacent airborne repeater stations 24; 2) adjacent airborne cluster controller repeater stations in a connected chain of airborne cluster controller repeater stations defined by network control 26; 3) airborne stations 12 and non-airborne stations 14, 16 or 18 and the airborne repeater 22 itself, and 4) ground station 28 and the airborne repeater 22 itself. An airborne repeater station 22 may simply relay communication traffic. Alternately, it may append communication traffic from onboard data terminal 110 to the traffic it is relaying. It may also remove from relayed traffic that traffic that it received which is intended for onboard data terminal 110.

According to the invention, airborne and non-airborne stations relay traffic between data terminal 110 and, preferably, airborne cluster controller repeater stations within line-of-sight that have been designated by network control 26 or have self-nominated themselves to serve as cluster controller repeater stations to handle communication traffic for the region in which the station is located.

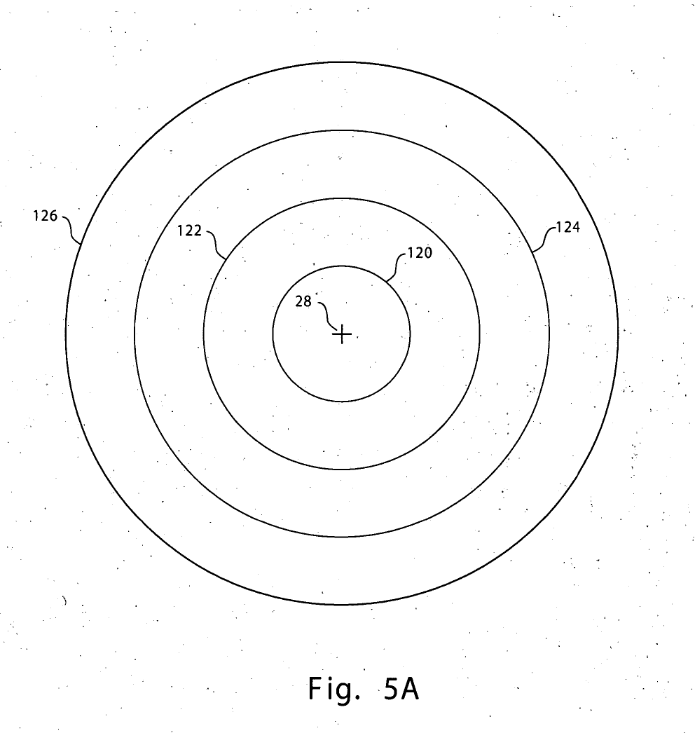

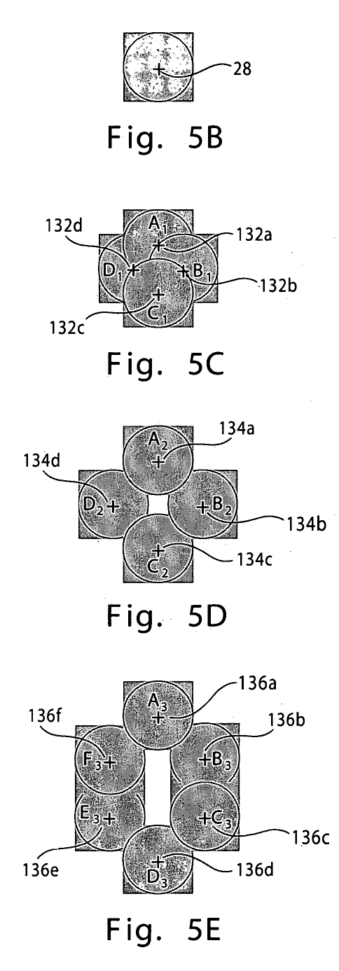

FIG. 5A shows a diagram depicting an ideal pattern of relay stations radiating from a ground station 28 in an airborne radio relay system 10 according to the present invention. Ideally the network control station 26 designates available aircraft to serve as cluster controller relay stations so that the aircraft are distributed on concentric circles radiating from the ground station 28. Thus, the ground station 28 itself may provide omni-directional coverage up to circle 120, an inner group of aircraft may be designated on inner circle 122 to serve as a first ring of relay stations, an intermediate group of aircraft may be designated on intermediate circle 124 to serve as a second ring of relay stations, and an outer group of aircraft may be designated on outer circle 126 to serve as a third ring of cluster controller relay stations.

FIGS. 5B through 5E show an exemplary disposition of coverage areas resulting from such a disposition of cluster controller relay stations. Thus, the shaded area in FIG. 5B shows the coverage area of the ground station; in FIG. 5C the shaded areas A₁, B₁, C₁ and D₁ show the coverage areas for four airborne relay stations 132a, 132b, 132c, and 132d, respectively, disposed on the inner circle 122; in FIG. 5D the shaded areas A₂, B₂, C₂ and D₂ show the coverage areas for four airborne relay stations 134a, 134b, 134c, and 134d, respectively, disposed on the intermediate circle 124 circle; and the shaded areas A₃, B₃, C₃, D₃, E₃ and F₃ in FIG. 5E show the coverage areas for four airborne relay stations 136a, 136b, 136c, 134d, 136e, and 136f respectively, disposed on the outer circle 126.

It will be noted that according to the present invention, no aircraft in the system is required to fly a designated route. Rather, the network control station 26 designates aircraft which happen to be disposed in the desired locations to serve as relay stations. Alternatively, some aircraft self-nominate themselves to function as airborne repeaters in circumstances where aircraft are not actively managed by an air traffic management authority such as the FAA: Ideally all aircraft on each of the circles 122, 124 and 126, respectively, would be equidistant from the ground station 28 and at the same altitude; however, given the state of flux of air traffic at any given time, variations from the ideal are expected, the network control station 26 simply selecting an optimal pattern from the existing air traffic pattern as disclosed by the air traffic control database.

It will further be noted that the number of concentric circles radiating from the ground station 28 will vary depending upon the size of the communication service area, the population of airborne terminals participating in the network, the acceptable quality of communications and the effective line-of-sight range at the frequency of interest. It will further be observed that the number of airborne cluster controller relay stations in any given circle will vary with the number of equipped aircraft available in the current air traffic scenario, and with the effective line-of-sight range at the frequency of interest. Thus the inner 122 and intermediate 124 circles may have four airborne relays disposed in a diamond pattern with decreasing areas of overlapping, coverage as shown by FIGS. 5C and 5D, while the outer circle has six airborne relays disposed in a hexagon. The shape of these areas may vary considerably with time as airborne platforms traverse their flight roughts.

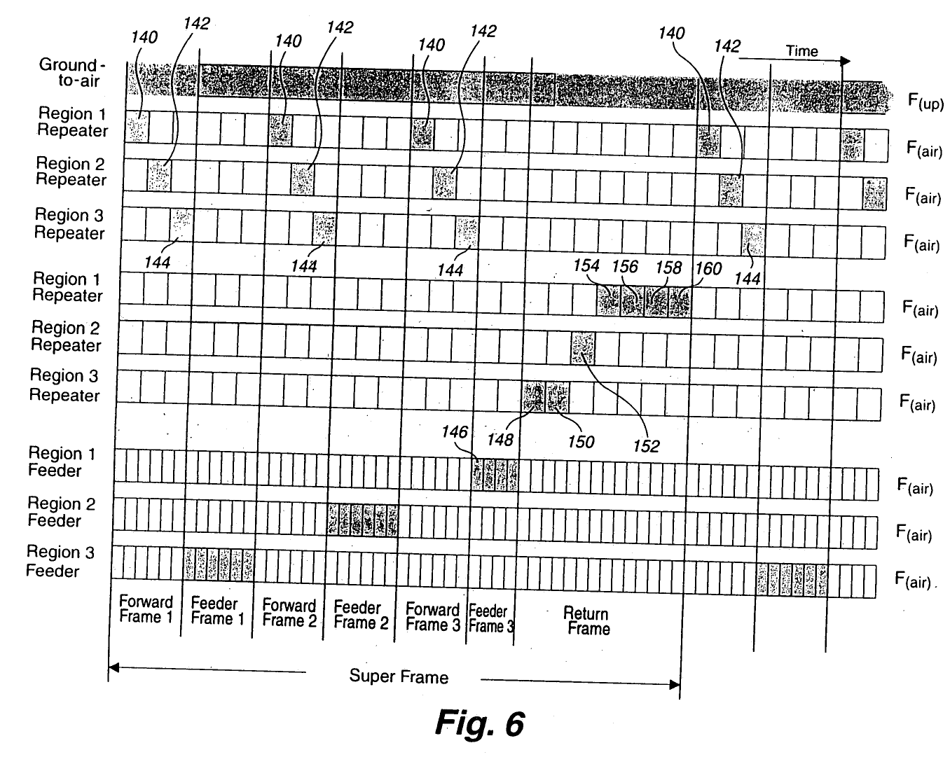

FIG. 6 shows schematically transmit/receive activity of ground station 28, airborne stations 12, 22, and, 24, and non-airborne stations 14, 16, and 18. For purposes of FIG. 6, the airborne stations and non-airborne stations may be considered to be geographically distributed into Region 1, corresponding to the inner ring coverage area shown in FIG. 5C, Region 2, corresponding to the intermediate ring coverage area shown in FIG. 5D, and Region 3, corresponding to the outer ring coverage area shown in FIG. 5E. According to the invention, central network-control 26 delivers ground-to-air (forward) traffic which includes signaling control traffic by which individual stations are notified to serve as airborne cluster controller repeater stations from ground-based network 20 to ground station 28. Ground station 28 transmits forward traffic, or fill-traffic if there is no forward traffic, continuously on radio frequency (RF) frequency Fᵤₚ. During each of intervals Forward Frame 1, Forward Frame 2, and Forward Frame 3, respectively, airborne repeater stations located in their designated regions sequentially transmit forward traffic on RF frequency Fₐᵢᵣ, thereby systematically extending the communication sub-network's coverage area first to inner ring Region 1, then intermediate ring Region 2, and then outer ring Region 3. This is done first by the four designated airborne repeater stations 132a-132d, shown in FIG. 5C, that during time slice 140 simultaneously relay forward traffic transmitted by ground station 28 that had been received by receiver 68 and accumulated in database 60 during the interval preceding the beginning of time slice 140.

Next four designated airborne repeater stations 134a-134d, shown in FIG. 5D, simultaneously relay during time slice 142 forward traffic received from airborne repeater stations 132a-132d during time slice 140 by receiver 62 and accumulated in database 60. Next six designated airborne repeater stations 136a-136f, shown in FIG. 5E, simultaneously relay during time slice 144 forward traffic received from airborne repeater stations 134a-134d that are within line-of-sight during time slice 142 by receiver 62 and accumulated in database 60.

Following time interval Forward Frame 1, Feeder Frame 1 commences, during which individual airborne stations 12 which have not been designated relay stations, and may therefore be termed terminal stations, and non-airborne stations 14, 16 and 18 transmit feeder traffic accumulated in database 96 during the period since the station last transmitted its feeder traffic (feeder traffic may be considered to be data traffic which has not entered the system through ground station 28). Terminals located in outer Region 3 transmit their feeder traffic to designated airborne repeater stations 136a-136f in Region 3 that are within line-of-sight on RF frequency Fₐᵢᵣ during Feeder Frame 1. Repeater stations 136a-136f in outer Region 3 receive this traffic on receiver 64 and accumulate the received feeder traffic in database 60.

Following the completion of time interval Forward Frame 2, Feeder Frame 2 commences and stations located in intermediate Region 2 transmit their feeder traffic to designated airborne repeater stations 134a-134d in intermediate Region 2 that are within line-of-sight on RF frequency Fair during Feeder Frame 2. Repeater stations 136a-136d in Region 2 receive this traffic on receiver 64 and accumulate the received feeder traffic in database 60.

Following the completion of time interval Forward Frame 3, Feeder Frame 3 commences and stations located in inner Region 1 transmit their feeder traffic to designated airborne repeater stations 132a-132d in inner Region 1 that are within line-of-sight on RF frequency Fₐᵢᵣ during Feeder Frame 3. Repeater stations 132a-132d in Region 1 receive this traffic on receiver 64 and accumulate the received feeder traffic in database 60.

Preferably, stations access the transmission channel to send their feeder traffic during small time slices 146 using a controlled random access transmission protocol such as the well know Carrier Sense Multiple Access with Collision Detection (CSMA-CD) protocol.

Following the completion of time interval Feeder Frame 3, airborne repeaters sequentially relay accumulated feeder traffic and any traffic from connected data terminals 80, collectively referred to as return traffic, on RF frequency Fₐᵢᵣ during the Return Frame time interval. First, designated airborne repeater stations outer Region 3 simultaneously transmit their return traffic during two distinct time slices 148 and 150. During time slice 148 repeater stations 136a, 136c, and 136e simultaneously transmit their return traffic, followed by repeater stations labeled 136b, 136d and 136f that simultaneously transmit their return traffic during, time slice 150. Designated airborne repeater stations 143a-134d in intermediate Region 2 that are within line-of-sight receive this return traffic on receiver 64 and accumulate it in database 60. Next, during time slice 152, designated airborne repeater stations 134a-134d in Region 2 simultaneously transmit the return traffic that has accumulated in database 60. Designated repeater stations 132a-132d in Region 1 receive this return traffic on receiver 64 and accumulate it in database 60. Next designated repeater stations 132a-132d in Region 1 transmit the accumulated return traffic in database 60 during four distinct time slices. During time slice 154, 156, 158 and 160 Region 1 airborne repeater stations 132a-132d, respectively, each transmits its accumulated return traffic. The return traffic is received by ground station 28, accumulated in database 40 and then forwarded to network control 26 for subsequent delivery to ground-based data network 20.

In order to achieve time synchronization in the time division multiple access (TDMA) system described above, the ground station 28 periodically transmits a timing synchronization pulse. This synchronization pulse is received by airborne repeater relays 132a-132d in the inner Region 1, and is sequentially relayed to airborne repeater relay stations in intermediate Region 2 and outer Region 3. Preferably, each time interval or time slice also includes a guard time to compensate for transmission path delays, as is common in TDMA systems.

Preferably, the present invention uses the TCP/IP protocol as a networking protocol, thereby allowing ensuring reliable communication, interconnection to virtually any network and access to the vast collection of TCP/IP protocols, tools and applications that are utilized by the Internet.

Although the airborne radio relay system 10 is preferably designed for use in the UHF frequency range, the system 10 may also be applied to communications in the VHF and microwave regions. It will be seen that the system 10 may be used not only for data telecommunications to and from aircraft, but may also be used to extend broadband wireless communication services to rural areas where conventional land based coverage may be inadequate, as well as to maritime communications. Advantageously, the use of a centralized network control 26 to designate airborne stations to serve as repeaters and the omnidirectional transmission patterns of the airborne stations reduces the processor demands and communication overhead traffic and simplifies the radio equipment required, resulting in a more economical and compact system of repeaters and a more efficient communication network.

A method of wireless data communications through an airborne radio relay system comprises the steps of: (a) establishing a network control station; (b) establishing a ground radio station, the network control station being in communication with the ground station, the ground station being capable of transmitting a radio frequency signal in an omnidirectional pattern; (c) equipping each aircraft in a plurality of aircraft with a radio station to define a plurality of airborne radio stations capable of sending and receiving packetized data communications, and capable of repeating packetized data communications, each said airborne radio station transmitting an omnidirectional radio pattern; (d) periodically accessing an air traffic control database in order to determine in real time the four dimensional location of said plurality of airborne radio stations in a current air traffic pattern; (e) dynamically selecting a plurality of airborne radio stations flying random flight paths in the current air traffic pattern to temporarily serve as airborne radio relay repeater stations, the selection being made by said net control-station after performing step (d); (f) multiplexing signaling control identifying the the selection of said airborne relay stations from said net control station with ground-to-air traffic to said plurality of airborne radio stations through said ground station; (g) uploading ground-to-air traffic on a first frequency; (h) relaying as air-to-air traffic on a second frequency the ground-to-air traffic; (i) airborne cluster controller relay stations collecting feeder traffic from airborne and non-airborne stations within their clusters on the second frequency; (j) relaying from airborne cluster controller to airborne cluster controller air-to-air traffic on the second frequency and (k) downloading air-to-ground traffic on the second frequency; wherein said airborne relay stations define a pattern of substantially concentric circles radiating radially from the ground station, the omnidirectional radio patterns transmitted by said airborne relay stations defining overlapping coverage areas to provide a continuous system of radio relays extending to and from the ground station in all directions.

It is to be understood that the present invention is not limited to the embodiments described above, but encompasses any and all embodiments within the scope of the following claims.

1. A data communication system for providing data communications between a data network and a user data terminal, comprising:
at least one cluster of data communication stations moving with respect to each other, the user data terminal being linked to a data communication system in the cluster, and
an assignment mechanism for dynamically assigning at least one of the data communication stations in the cluster with a function of a cluster controller to transmit data packets from the data network to at least one other data communication station in the cluster.

2. The system of claim 1, wherein the cluster controller function is assigned for a predetermined time interval.

3. The system of claim 1, wherein the cluster controller function is assigned based on a current location of the data communication station being assigned.

4. The system of claim 1, wherein the cluster controller function is assigned based on a predicted location of the data communication station being assigned.

5. The system of claim 1, wherein the cluster controller function is assigned based on ability of the data communication station being assigned to provide data communications between the data communication stations in a predetermined geographic area.

6. The system of claim 1, wherein the cluster controller function is assigned based on ability of the data communication station being assigned to provide data communications between the maximum number of the data communication stations in the cluster.

7. The system of claim 1, wherein the cluster controller function is assigned based on ability of the data communication station being assigned to provide data communications with predetermined data communication stations in the cluster.

8. The system of claim 1, wherein the assignment mechanism is configured to direct a data communication station in the cluster to perform the cluster controller function.

9. The system of claim 1, wherein the assignment mechanism is configured to enable a data communication station in the cluster to request the cluster controller function.

10. The system of claim 1, wherein the assignment mechanism is configured to assign the cluster controller function based on position data describing current and anticipated positions of the data communication stations.

11. The system of claim 10, wherein the position data include air traffic control data describing four-dimensional physical location of aircraft carrying a data communication station.

12. The system of claim 1, wherein the data communication station is linked to a local area network including the user data terminal.

13. The system of claim 1, wherein the data communication station includes a receiver for receiving a data communication signal carrying data from the data network.

14. The system of claim 12, wherein the data communication station further includes a transmitter and a receiver for providing data communications with other data communication stations.

15. The system of claim 1, wherein multiple clusters of data communication stations are provided.

16. The system of claim 1, wherein the data network includes the Internet.

17. The system of claim 1, wherein the data network includes a private network.

18. The system of claim 1, wherein the data network includes a public network.

19. The system of claim 1, wherein at least one data communication station is carried on an airborne platform.

20. The system of claim 19, wherein the trajectory of the airborne platform is independent from and not controlled by the system of claim 1.

21. The system of claim 19, wherein the airborne-platform is able to periodically return to ground.

22. The system of claim 1, wherein at least one data communication station in the cluster is included in multiple virtual data communication networks.

23. In a data communication system for providing transmission of data packets between a data network and a cluster of data communication stations moving with respect to each other, a data communication station of the cluster comprising:
receiving and transmitting circuitry for providing data communications with other data communication stations and with the data network,
the communication station being dynamically assigned to operate as a cluster controller during a predetermined time interval to receive data packets from the data network for transmission to another data communication station in the cluster.

24. The data communication station of claim 23, wherein the receiving and transmitting circuitry is configured for receiving an assignment signal to assign the communication station as the cluster controller.

25. The data communication station of claim 24, wherein the assignment signal is provided by a central controller.

26. The data communication station of claim 24, wherein the assignment signal is provided by one of the communication stations in the cluster.

27. The data communication station of claim 26, wherein the assignment signal is provided by a data communication station operating as the cluster controller during a previous time interval.

28. A method of data communications between a data network and a user data terminal linked to a data communication station in a cluster of data communication stations moving with respect to each other, the method comprising the steps of:
assigning a function of a first cluster controller to a first data communication station in the cluster, to enable the first data communication station to transmit first data packets from the data network to other data communication stations in the cluster in a first predetermined time period, and
assigning a function of a second cluster controller to a second data communication station in the cluster, to enable the second data communication station to transmit second data packets from the first cluster controller to other data communication stations in a cluster of the second cluster controller in a second predetermined time period.

29. The method of claim 28, wherein a cluster controller function is assigned by a central controller.

30. The method of claim 29, wherein the second data communication station is assigned with the cluster controller function by the first data communication station.

31. The method of claim 30, wherein a data communication signal sent from the second data communication to a third data communication station after the second data communication station is assigned with the cluster controller function is received by the first data communication station as an acknowledgement signal.

32. A data communication system for providing data communications between a data network and a user data terminal, comprising:
at least one cluster of data communication stations moving with respect to each other, the user data terminal being linked to a data communication system in the cluster, and
an assignment mechanism for dynamically assigning at least one of the data communication stations in the cluster with a function of a cluster controller to transmit to the data network a data packet received from at least one other data communication station in the cluster.

33. A method of data communications between a data network and a user data terminal linked to a data communication station in a cluster of data communication stations moving with respect to each other, the method comprising the steps of:
assigning a function of a first cluster controller to a first data communication station in the cluster, to enable the first data communication station to transmit to the data network first data packets received from other data communication stations in the cluster in a first predetermined time period, and
assigning a function of a second cluster controller to a second data communication station in the cluster, to enable the second data communication station to transmit to the first cluster controller second data packets received from other data communication stations in a cluster of the second cluster controller in a second predetermined time period.
